(19) United States
(12) Patent Application Publication
(10) Pub. No.: US 2012/0112029 A1
(43) Pub. Date: May 10, 2012

(54) STAND FOR BOARD SPORTS EQUIPMENT

(76) Inventor: David Ellis Wong, La Habra, CA (US)

(21) Appl. No.: 13/332,859

(22) Filed: Dec. 21, 2011

(51) Int. Cl. A63B 71/00; B23P 17/04

(52) U.S. Cl. 248/346.5; 29/426.2

(57) ABSTRACT

A stand for a sports board includes left and right upright monolithic skids. Each skid includes a base portion having a base bottom surface, and front and rear lobes extending upward from the base portion. Each lobe includes an uppermost surface. There is a left recession between the left front lobe and left rear lobe, and a right recession between the right front lobe and right rear lobe. A most-recessed surface of the left recession is closer to the left base bottom surface than are the left front lobe uppermost surface and the left rear lobe uppermost surface, and a most-recessed surface of the right recession is closer to the right base bottom surface than are the right front lobe uppermost surface and the right rear lobe uppermost surface. A spacer bar engages with and separates the left and right upright monolithic skids, with the stand in an operable configuration.

### FIELD OF THE INVENTION

The present invention relates generally to the field of board sports equipment, and more particularly to stands and racks for board sports equipment.

### BACKGROUND

Several sports include the use of a board as essential equipment, and so may be referred to as “board sports.” Board sports include, for example, skateboarding, snowboarding, wakeboarding, surfing, paddelboarding, windsurfing, and kitesurfing.

In the sport of surfing, a surfer stands, kneels, or lies on a surfboard. Surfboards come in various sizes, the smallest being so-called “boogie boards” (upon which most surfers rarely stand), and the largest being so-called “stand-up paddle” (SUP) boards (upon which a surfer is usually in a standing position). So-called “short boards” and “long boards” are surfboards (upon which a surfer typically alternates between prone and kneeling or standing positions) and that are larger than boogie boards but smaller than SUP boards.

Windsurfing boards can range in size from being approximately the size of a short board, to being the size of a SUP board. Paddle boards, which include ocean rescue paddle boards, may be as large as, and often even longer than, SUP boards. Kitesurfing boards are generally smaller than short boards, but larger than boogie boards. Skateboards are generally narrower and smaller than boogie boards, but some specialty skateboards can approximate the length of a short board. Snowboards are generally narrower and smaller than short boards, while being longer than most skateboards.

The users of many surfboards, paddle boards, windsurfing boards, etc desire to protect the surfaces of the board from contact with the ground during storage, while rinsing equipment, temporarily after traveling to a location of intended use, or before departing from such a location, etc. Otherwise, features of the ground may damage or soil one or more surfaces of the board. However, conventional racks for surfboard storage may be unwieldy or inconvenient to transport, occupy too much space during transport, have inadequate performance or reliability, and/or be costly to manufacture. Therefore, there is a need in the art for an improved stand for board sports equipment.

### SUMMARY

A stand for a sports board includes left and right upright monolithic skids. Each skid includes a base portion having a base bottom surface, and front and rear lobes extending upward from the base portion. Each lobe includes an uppermost surface. There is a left recession between the left front lobe and left rear lobe, and a right recession between the right front lobe and right rear lobe. A most-recessed surface of the left recession is closer to the left base bottom surface than are the left front lobe uppermost surface and the left rear lobe uppermost surface, and a most-recessed surface of the right recession is closer to the right base bottom surface than are the right front lobe uppermost surface and the right rear lobe uppermost surface. A spacer bar engages with and separates the left and right upright monolithic skids, with the stand in an operable configuration.

### BRIEF DESCRIPTION OF THE DRAWINGS

FIG. 1 is a perspective view of a stand for a sports board, according to an embodiment of the present invention, in an assembled and operable configuration.

FIG. 2 depicts the stand of FIG. 1, except in a pre-assembly configuration.

FIG. 3 depicts ten stands for sports boards, according to an embodiment of the present invention, in a pre-assembly configuration.

### DETAILED DESCRIPTION

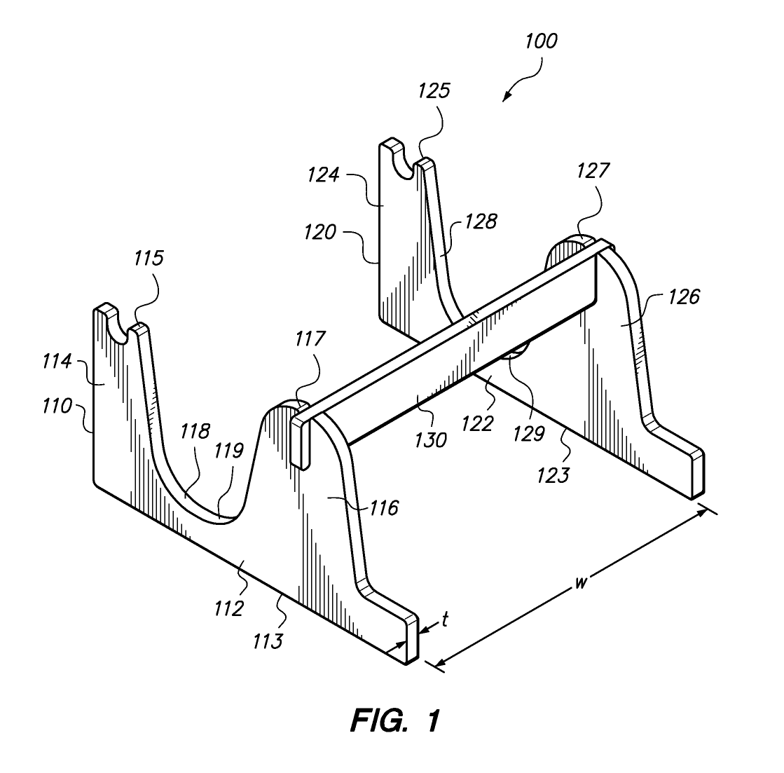

FIG. 1 is a perspective view of a stand 100 for a sports board, according to an embodiment of the present invention. The stand 100 includes a left upright monolithic skid 110, a right upright monolithic skid 120, and a spacer bar 130 engaged with and separating the left upright monolithic skid 110 and the right upright monolithic skid 120, with the stand 100 in an assembled and operable configuration (as shown).

Each of the left and right upright monolithic skids may define a thickness t. In certain embodiments, the left and right upright monolithic skids 110, 120 each comprises a rigid foam slab, and the thickness t is in the range 10 mm to 25 mm. In certain other embodiments, the left and right upright monolithic skids 110, 120 each comprises a plywood board and the thickness t is in the range 10 mm to 50 mm. The left and right upright monolithic skids 110, 120 may alternatively comprise other suitable materials, for example an injection-molded plastic material. In certain embodiments, the foregoing materials and dimensional ranges may provide adequate strength for the stand 100 to support a variety of board sports equipment, and suitable durability, mass density, and resistance to water damage for prolonged periodic use.

In the embodiment of FIG. 1, the left upright monolithic skid 110 includes a left base portion 112 having a left base bottom surface 113. The left upright monolithic skid 110 includes a left front lobe 114 extending upward from the left base portion 112. The left front lobe 114 includes a left front lobe uppermost surface 115. The left upright monolithic skid 110 includes a left rear lobe 116 extending upward from the left base portion 112. The left rear lobe 116 includes a left rear lobe uppermost surface 117. The left upright monolithic skid 110 includes a left recession 118 between the left front lobe 114 and left rear lobe 116. A most-recessed surface 119 of the left recession 118 is closer to the left base bottom surface 113 than are the left front lobe uppermost surface 115 and the left rear lobe uppermost surface 117.

In the embodiment of FIG. 1, the right upright monolithic skid 120 includes a right base portion 122 having a right base bottom surface 123. The right upright monolithic skid 120 includes a right front lobe 124 extending upward from the right base portion 122. The right front lobe 124 includes a right front lobe uppermost surface 125. The right upright monolithic skid 120 includes a right rear lobe 126 extending upward from the right base portion 122. The right rear lobe 126 includes a right rear lobe uppermost surface 127. The right upright monolithic skid 120 includes a right recession 128 between the right front lobe 124 and right rear lobe 126. A most-recessed surface 129 of the right recession 128 is closer to the right base bottom surface 123 than are the right front lobe uppermost surface 125 and the right rear lobe uppermost surface 127.

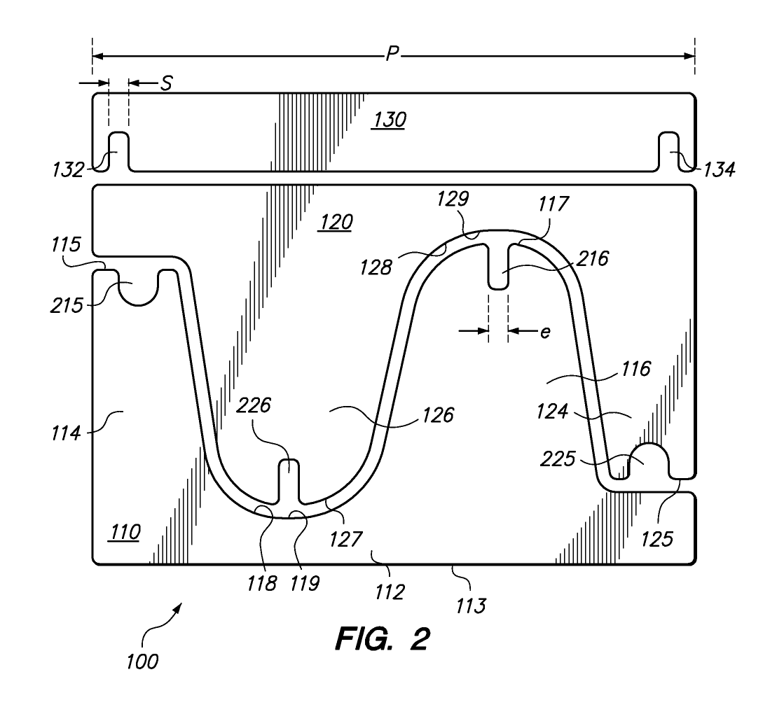

FIG. 2 depicts the stand 100 in a pre-assembly configuration. The pre-assembly configuration shown in FIG. 2 is one example of many alternative transport or storage configurations—in this example with the components of the stand 100 being laid adjacent to each other. Note that the spacer bar 130 is not engaged with the left upright monolithic skid 110 and the right upright monolithic skid 120 with the stand 110 in the configuration of FIG. 2. Such a transport or storage configuration requires less space for transport than does the operable configuration of the stand 100 that is shown in FIG. 1. Other possible transport or storage configurations may be even more compact than that of FIG. 2, for example with one or more of the components of the stand 100 being laid on top of one another for transport and/or storage.

In the embodiment of FIGS. 1-2, the spacer bar 130 is horizontal and engages with the left upright monolithic skid 110 at the left rear lobe 116 and engages with the right upright monolithic skid 120 at the right rear lobe 126. In certain embodiments, the spacer bar 130 may preferably separate the left upright monolithic skid 110 from the right upright monolithic skid 120 by an inter-skid distance w in the range 0.4 m to 0.8 m. For example, in certain embodiments, the spacer bar 130 may comprise a plywood plank having a total plank length P in the range 0.3 m to 1.2 m. In certain embodiments, the foregoing dimensional ranges may enhance the ability of the stand 100 to support a variety of board sports equipment.

In the embodiment of FIGS. 1-2, the left rear lobe 116 may include a first lobe slot 216, and the right rear lobe 126 may include a second lobe slot 226. As shown in FIG. 2, the first and second lobe slots 216, 226 may each define a lobe slot width e. The spacer bar 130 may include a first spacer bar slot 132 and a second spacer bar slot 134. In such an embodiment, the first lobe slot 216 may be engaged with the first spacer bar slot 132, and the second lobe slot 226 may be engaged with the second spacer bar slot 134 (as shown in the assembled and operable configuration of FIG. 1). As shown in FIG. 2, the first and second spacer bar slots 132, 134 may each define a spacer bar slot width S.

In certain embodiments, the left and right upright monolithic skids 110, 120, and the spacer bar 130, are preferably fabricated from (e.g. cut or otherwise separated from) a common substantially rectangular pattern region of a starting material (e.g. a monolithic slab of plywood or foam). In such embodiments, the left and right upright monolithic skids 110, 120, and the spacer bar 130, may have approximately the same thickness, and so in such embodiments S and e are preferably equal. For example, in certain embodiments, the spacer bar 130 comprises a rigid foam plank and the spacer bar slot width s preferably may be in the range 10.5 mm to 27 mm.

In the embodiment of FIGS. 1 and 2, the left front lobe uppermost surface 115 is preferably but not necessarily 150 mm to 350 mm from the left rear lobe uppermost surface 117, and the right front lobe uppermost surface 125 is preferably but not necessarily 150 mm to 350 mm from the right rear lobe uppermost surface 127. In certain embodiments, such dimensional ranges may enhance the ability of the stand 100 to support a variety of board sports equipment. The left front lobe 114 optionally includes a first concave oar saddle groove 215 that preferably has an internal radius of curvature in the range 25 mm to 60 mm. Likewise, the right front lobe 124 optionally includes a first concave oar saddle groove 225 that preferably has an internal radius of curvature in the range 25 mm to 60 mm. In certain embodiments, such a range for the internal radius of curvature may enable the first and second concave oar saddle grooves 215, 225 to conveniently hold an oar for a stand-up paddle board, for example.

In the embodiment of FIG. 2, the left recession 118 defines a left recession concave contour that includes the most-recessed surface 119 of the left recession 118, and the right recession 128 defines a right recession concave contour that includes the most-recessed surface 129 of the right recession 128. Also, the right rear lobe 126 defines a right rear lobe convex contour that includes the right rear lobe uppermost surface 127, and the left rear lobe 116 defines a left rear lobe convex contour that includes the left rear lobe uppermost surface 117. In certain embodiments, each of the left and right recession concave contours preferably defines a recession concave contour minimum radius of curvature that is no less than 70 mm. In certain embodiments, such a minimum radius of curvature may enhance the ability of the stand 100 to support a variety of board sports equipment.

In the embodiment of FIG. 2, the left and right upright monolithic skids 110 and 120 have substantially the same shape and size. For example, the left recession concave contour substantially matches the right rear lobe convex contour. “Substantially matches” in this context means that the right rear lobe convex contour, if oriented to be disposed within the left recession concave contour (as shown in FIG. 2), generally follows the left recession concave contour except for discrete features (e.g. the second lobe slot 226), and fits within the left recession concave contour.

Likewise, for example, the right recession concave contour substantially matches the left rear lobe convex contour. “Substantially matches” in this context means that the left rear lobe convex contour, if oriented to be disposed within the right recession concave contour (as shown in FIG. 2), generally follows the right recession concave contour except for discrete features (e.g. the first lobe slot 216), and fits within the right recession concave contour. In certain embodiments, the aforesaid substantial matching may enhance the efficiency with which the raw or starting material is used during manufacture of the stand 100, and therefore may reduce manufacturing costs.

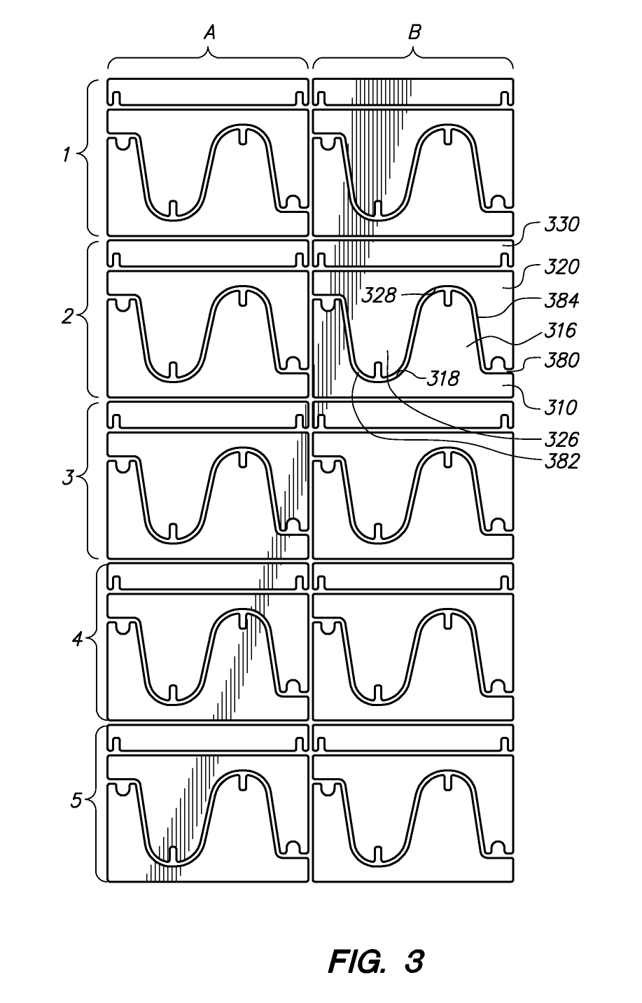

FIG. 3 depicts ten stands for sports boards, according to an embodiment of the present invention, in a pre-assembly configuration. The ten stands for sports boards are arranged in ten substantially rectangular pattern regions oriented in five rows (1, 2, 3, 4, 5) and two columns (A, B). Hence, the ten stands depicted in FIG. 3 can be identified by row and column as: A1, A2, A3, A4, A5, B1, B2, B3, B4, and B5.

The ten substantially rectangular pattern regions of the embodiment of FIG. 3 may be separated from a monolithic slab of starting material, such as plywood, rigid foam, or injection molded plastic. Further, the left and right monolithic skids of each stand may be separated from each other along a separation contour that divides them. For example, in the stand B2, the left monolithic skid 310 may be separated from the right monolithic skid 320 along a separation contour 380, by cutting and/or melting along the separation contour 380.

In the embodiment of FIG. 3, the separation contour 380 defines the recessions and lobes of the left monolithic skid 310 and of the right monolithic skid 320. Specifically, in the embodiment of FIG. 3, the separation contour 380 includes a first separation contour segment 382 that defines the left recession 318 and the right rear lobe 326, and the separation contour 380 includes a second separation contour segment 384 that defines the right recession 328 and the left rear lobe 316. In this way, a single cut or separation contour segment may help define more than one component of one or more of the ten stands depicted in FIG. 3. In certain embodiments, such a method or arrangement may decrease the per-stand time and/or cost associated with stand manufacture.

In the foregoing specification, the invention is described with reference to specific exemplary embodiments, but those skilled in the art will recognize that the invention is not limited to those. It is contemplated that various features and aspects of the invention may be used individually or jointly and possibly in a different environment or application. The specification and drawings are, accordingly, to be regarded as illustrative and exemplary rather than restrictive. For example, the word “preferably,” and the phrase “preferably but not necessarily,” are used synonymously herein to consistently include the meaning of “not necessarily” or optionally. “Comprising,” “including,” and “having,” are intended to be open-ended terms.

What is claimed is:

1. A stand for a sports board, the stand comprising:
a left upright monolithic skid including
a left base portion having a left base bottom surface;
a left front lobe extending upward from the left base portion, the left front lobe including a left front lobe uppermost surface;
a left rear lobe extending upward from the left base portion, the left rear lobe including a left rear lobe uppermost surface; and
a left recession between the left front lobe and left rear lobe, a most-recessed surface of the left recession being closer to the left base bottom surface than are the left front lobe uppermost surface and the left rear lobe uppermost surface;
a right upright monolithic skid including
a right base portion having a right base bottom surface;
a right front lobe extending upward from the right base portion, the right front lobe including a right front lobe uppermost surface;
a right rear lobe extending upward from the right base portion, the right rear lobe including a right rear lobe uppermost surface; and
a right recession between the right front lobe and right rear lobe, a most-recessed surface of the right recession being closer to the right base bottom surface than are the right front lobe uppermost surface and the right rear lobe uppermost surface; and
a spacer bar engaged with and separating the left upright monolithic skid and the right upright monolithic skid, with the stand in an operable configuration.

2. The stand of claim 1 wherein each of the left and right upright monolithic skids comprises a rigid foam slab having a slab thickness in the range 10 mm to 25 mm.

3. The stand of claim 2 wherein the spacer bar comprises a rigid foam plank that includes two spacer bar slots, each spacer bar slot having a slot width in the range 10.5 mm to 27 mm.

4. The stand of claim 1 wherein each of the left and right upright monolithic skids comprises a plywood board having a board thickness in the range 10 mm to 50 mm.

5. The stand of claim 4 wherein the spacer bar comprises a plywood plank having a plank length in the range 0.3 m to 1.2 m.

6. The stand of claim 1 wherein each of the left and right upright monolithic skids comprises an injection-molded plastic material.

7. The stand of claim 1 wherein the spacer bar is horizontal and engages with the left upright monolithic skid at the left rear lobe and engages with the right upright monolithic skid at the right rear lobe.

8. The stand of claim 7 wherein the left rear lobe includes a first lobe slot, the right rear lobe includes a second lobe slot, the spacer bar includes first and second spacer bar slots, the first lobe slot being engaged with the first spacer bar slot, and the second lobe slot being engaged with the second spacer bar slot.

9. The stand of claim 1 wherein the left and right upright monolithic skids have substantially the same shape and size.

10. The stand of claim 9 wherein the left recession defines a left recession concave contour that includes the most-recessed surface of the left recession, and the right rear lobe defines a right rear lobe convex contour that includes the right rear lobe uppermost surface, and wherein the left recession concave contour substantially matches the right rear lobe convex contour.

11. The stand of claim 10 wherein the right recession defines a right recession concave contour that includes the most-recessed surface of the right recession, and the left rear lobe defines a left rear lobe convex contour that includes the left rear lobe uppermost surface, and wherein the right recession concave contour substantially matches the left rear lobe convex contour.

12. The stand of claim 11 wherein each of the left and right recession concave contours defines a recession concave contour minimum radius of curvature that is no less than 70 mm.

13. The stand of claim 9 wherein the left front lobe uppermost surface is 150 mm to 350 mm from the left rear lobe uppermost surface.

14. The stand of claim 1 wherein the spacer bar separates the left upright monolithic skid from the right upright monolithic skid by an inter-skid distance of 0.4 m to 0.8 m.

15. The stand of claim 1 wherein each of the left front lobe and the right front lobe includes a concave oar saddle groove having an internal radius of curvature in the range 25 mm to 60 mm.

16. The stand of claim 1 wherein the spacer bar is not engaged with the left upright monolithic skid and the right upright monolithic skid with the stand in a transport configuration.

17. A method to manufacture a stand for a sports board, the method comprising:
providing a monolithic slab that includes a substantially rectangular pattern region;
separating a left monolithic skid and a right monolithic skid from the substantially rectangular pattern region of the monolithic slab, the left monolithic skid being separated from the right monolithic skid along a separation contour that divides the left monolithic skid from the right monolithic skid;
wherein the left monolithic skid includes a left recession between a left front lobe and a left rear lobe, and the right monolithic skid includes a right recession between a right front lobe and a right rear lobe; and
wherein the separation contour includes a first separation contour segment that defines the left recession and the right rear lobe, and the separation contour includes a second separation contour segment that defines the right recession and the left rear lobe; and
providing a spacer bar adapted to engage with and separate the left and right monolithic skids.

18. The method of claim 17 wherein providing the spacer bar comprises separating an elongated monolithic plank from the monolithic slab adjacent one of the left and right monolithic skids.

19. The method of claim 18 wherein separating the left monolithic skid and the right monolithic skid from the substantially rectangular pattern region of the monolithic slab comprises cutting the monolithic slab along the separation contour.

20. The method of claim 18 wherein separating the left monolithic skid and the right monolithic skid from the substantially rectangular pattern region of the monolithic slab comprises melting the monolithic slab along the separation contour.
